(19) United States
(12) Patent Application Publication
(10) Pub. No.: US 2026/0285055 A1
(43) Pub. Date: Sep. 24, 2026

(54) IMAGE PROCESSING APPARATUS, IMAGE PROCESSING METHOD, AND NON-TRANSITORY RECORDING MEDIUM

(71) Applicant: Keisuke TAKASHIMA, Kanagawa (JP)

(72) Inventor: Keisuke TAKASHIMA, Kanagawa (JP)

(73) Assignee: Ricoh Company, Ltd., Tokyo (JP)

(21) Appl. No.: 19/569,438

(22) Filed: Mar. 17, 2026

(30) Foreign Application Priority Data
Mar. 24, 2025 (JP) 2025-048621
Dec. 17, 2025 (JP) 2025-260676

(51) Int. Cl. B41J 2/205; B41J 2/045

(52) U.S. Cl. CPC B41J 2/2056; B41J 2/04541

(57) ABSTRACT

An image processing apparatus includes a reading sensor to read an image, a black image providing object to provide a black image for calculating an amount of density fluctuation due to stray light, and circuitry to calculate the amount of density fluctuation based on a first black image and a second black image read by the reading sensor in states where a light source is turned on and off for the black image providing object, respectively, and correct the image read by the reading sensor using the amount of density fluctuation.

### CROSS-REFERENCE TO RELATED APPLICATIONS

This patent application is based on and claims priority pursuant to 35 U.S.C. § 119(a) to Japanese Patent Application Nos. 2025-048621, filed on Mar. 24, 2025 and 2025-260676, filed on Dec. 17, 2025, in the Japan Patent Office, the entire disclosure of which is hereby incorporated by reference herein.

### BACKGROUND

### Technical Field

The present disclosure relates to an image processing apparatus, an image processing method, and a non-transitory recording medium.

### Related Art

In order to enhance image quality, some image processing apparatuses, such as a line head printer, read printed matter to generate a read image using a reading device such as an in-line sensor, and then correct, based on the read image, a density difference for each of the heads that eject liquid (ink) to perform image processing. In such an apparatus, when performing correction of the reading of the in-line sensor, black shading correction is typically performed to correct the influence of dark current noise on a read value obtained by reading the printed matter.

It is known that the in-line sensor can suffer from a phenomenon known as stray light, in which light enters through paths other than the originally intended optical path and affects the read image. One typical method for correcting the stray light is to correct the stray light together with the dark current noise using the black shading correction.

For example, an apparatus has been proposed that reads an image using a contact image sensor, and in order to obtain high-quality image data, simultaneously performs dark output correction after removing a stray light component that is generated when a light source is turned on and sensitivity correction.

### SUMMARY

The present disclosure described herein provides an image processing apparatus including a reading sensor to read an image, a black image providing object to provide a black image for calculating an amount of density fluctuation due to stray light, and circuitry to calculate the amount of density fluctuation based on a first black image and a second black image read by the reading sensor in states where a light source is turned on and off for the black image providing object, respectively, and correct the image read by the reading sensor using the amount of density fluctuation.

The present disclosure described herein further provides an image processing method including calculating an amount of density fluctuation based on a first black image and a second black image read by a reading sensor, respectively, in states where a light source is turned on and off for a black image providing object used for calculating the amount of the density fluctuation due to stray light, reading, with the reading sensor, an image used for performing density correction, and correcting the image read by the reading sensor using the amount of the density fluctuation.

The present disclosure described herein further provides a non-transitory recording medium storing a plurality of program codes which, when executed by one or more processors, causes the one or more processors to perform a method including calculating an amount of density fluctuation based on a first black image and a second black image read by a reading sensor, respectively, in states where a light source is turned on and off for a black image providing object used for calculating the amount of the density fluctuation due to stray light, reading, with the reading sensor, an image used for performing density correction, and correcting the image read by the reading sensor using the amount of the density fluctuation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image processing apparatus;

FIG. 2 is a diagram illustrating a configuration of a registration/image forming device included in an image processing apparatus;

FIGS. 3A and 3B are enlarged views of the periphery of an in-line sensor according to a comparative example;

FIGS. 4A and 4B are diagrams each illustrating black shading adjustment;

FIG. 5 is a diagram illustrating issues in canceling a stray light component;

FIG. 6 is a diagram illustrating a configuration of the periphery of a reading device included in an image processing apparatus according to a first example;

FIG. 7 is a block diagram illustrating a hardware configuration and a functional configuration of an image processing apparatus;

FIG. 8 is a flowchart of a process performed by an image processing apparatus;

FIG. 9 is a diagram illustrating a configuration of the periphery of a reading device included in an image processing apparatus according to a second example; and

FIG. 10 is a diagram illustrating a configuration of the periphery of a reading device included in an image processing apparatus according to a third example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure is described with reference to the following embodiments, but the present disclosure is not limited to the embodiments described herein.

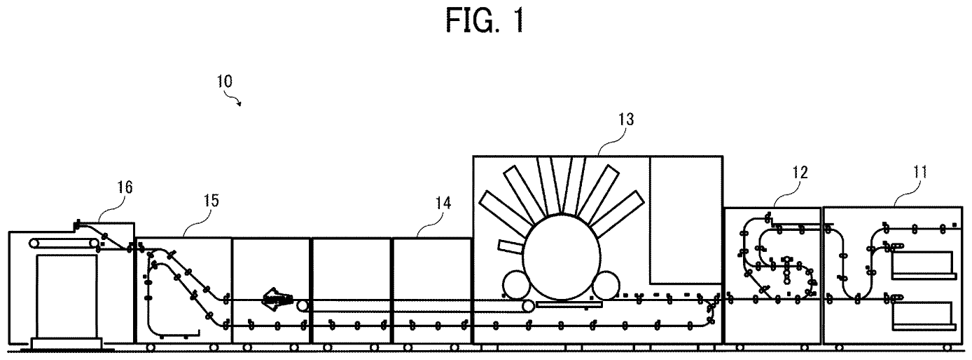

FIG. 1 is a diagram illustrating a configuration of an image processing apparatus 10. The image processing apparatus 10 may be any type of apparatus that can read an image and perform density correction on an image. An example of the image processing apparatus is a line head printer having a duplex printing function, but is not limited thereto. In the following description, the image processing apparatus 10 is described as a line head printer having a duplex printing function. A line head refers to a head that performs recording on a sheet, as a recording medium, conveyed under the head that is fixed. The head has fine nozzles, and is a mechanism that ejects liquid (ink) from the nozzles toward the sheet to reproduce print data as, for example, an image, on the sheet.

The sheet may be a thin sheet made from any material. Example of the sheet include a sheet made from paper such as a paper sheet or a postcard, a sheet made from cloth, and a film such as an overhead projector (OHP) transparency. In the following description, the sheet is described as a paper sheet.

The image processing apparatus 10 includes a sheet feeding device 11, a pre-coating device 12, and a registration/image forming device 13. The sheet feeding device 11 stores multiple paper sheets including the paper sheet, and separates and feeds the paper sheets one by one. The pre-coating device 12 applies a pre-coating liquid (undercoat liquid) to the paper sheet. The pre-coating liquid facilitates fixing of ink according to the paper sheet.

The registration/image forming device 13, in a registration section, detects the position (registration) of the paper sheet in the main scanning direction and the sub-scanning direction relative to the image and corrects the positional deviation in the main scanning direction and the sub-scanning direction. The registration/image forming device 13, in the registration section, also detects the inclination (skew) of the paper sheet and corrects the inclination. The sub-scanning direction is a sheet conveyance direction. The main scanning direction is a direction perpendicular to the sub-scanning direction.

In an image forming section of the registration/image forming device 13, the paper sheet corrected in the registration section is transferred to an image forming drum from an inlet cylinder. The paper sheet passes under the line head while being attracted to the image forming drum, and ink is discharged from the line head at that time. Thus, printing is performed on the paper sheet. Subsequently, the paper sheet is transferred to an outlet cylinder and is conveyed downstream.

The image processing apparatus 10 further includes a drying/cooling device 14, a reversing device 15, and a sheet ejecting device 16. The drying/cooling device 14, in a drying section, dries the paper sheet to remove the moisture of the ink on the paper sheet and fixes, on the paper sheet, the image formed by the discharge of the ink. The drying/cooling device 14 cools, in a cooling section, the paper sheet having a high temperature as needed.

The reversing device 15 performs a switchback reversal at the time of automatic printing on the back side of the paper sheet, and conveys the paper sheet toward the side where the registration/image forming device 13 is located. The sheet ejecting device 16 sequentially ejects the paper sheet on which the printing is completed.

In the image processing apparatus 10, the sheet feeding device 11, the pre-coating device 12, the registration/image forming device 13, the drying/cooling device 14, the reversing device 15, and the sheet ejecting device 16 are arranged in a line from right to left. The paper sheet is conveyed from the sheet feeding device 11 on the right side to the sheet ejecting device 16 on the left side for printing.

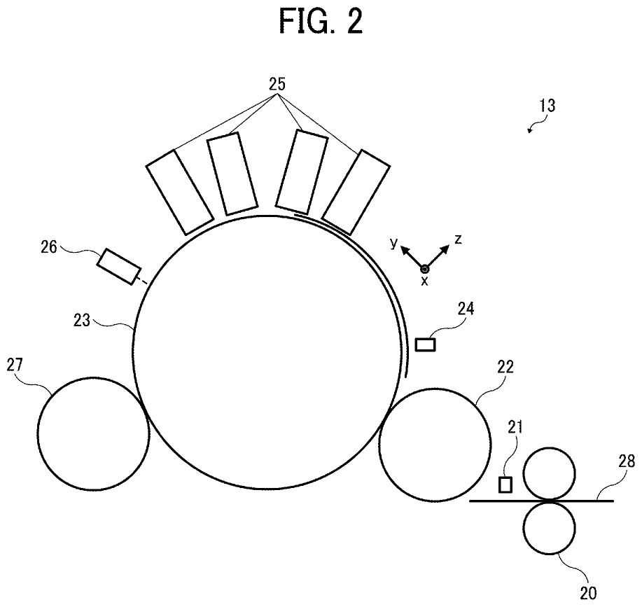

FIG. 2 is a diagram illustrating a configuration of the registration/image forming device 13 included in the image processing apparatus 10. The registration/image forming device 13 includes a roller 20, a sheet leading-edge sensor 21, an inlet cylinder 22, an image forming drum 23, a print timing sensor 24, a print head (line head) 25, an in-line sensor 26, and an outlet cylinder 27.

The sheet leading-edge sensor 21 is disposed downstream of the roller 20 in the conveyance direction of a paper sheet 28, and detects the leading edge of the paper sheet passing under the roller 20 first. The roller 20 finely adjusts the timing of gripping and conveying the paper sheet to the inlet cylinder 22 based on the relationship between the timing when the paper sheet passes the sheet leading-edge sensor 21 and the rotation encoder of the image forming drum 23.

The paper sheet 28 is conveyed to the inlet cylinder 22. The leading edge of the paper sheet 28 is gripped by a sheet conveyance claw (gripper) that is attached to the inlet cylinder 22 and opens and closes mechanically. The inlet cylinder 22, the image forming drum 23, and the outlet cylinder 27 are connected by gears. The paper sheet 28 is conveyed from the inlet cylinder 22 to the outlet cylinder 27 via the image forming drum 23 while being gripped sequentially by a gripper attached to the image forming drum 23 and a gripper attached to the outlet cylinder 27.

Heads that eject respective color inks are disposed over the paper sheet 28 that is conveyed so as to be wound around the surface of the image forming drum 23 located between the inlet cylinder 22 and the outlet cylinder 27. The colors of the color inks are, for example, black, yellow, magenta, and cyan. These colors are given by way of example. The colors may be black only, two or three of these colors, or may include another color in addition to these four colors, or may be any other colors or a combination thereof.

The print head 25 includes multiple heads for respective colors, which are aligned in the main scanning direction. When the paper sheet 28 passes under the print head 25, the inks are ejected from the heads of the respective colors to form an image on the paper sheet 28. The timing at which the heads of respective colors eject the inks is determined based on the timing at which the paper sheet 28 passes under the print timing sensor 24 located upstream of the heads of respective colors.

The in-line sensor 26 is disposed over the image forming drum 23 at a position separated from the image forming drum 23. The in-line sensor 26 reads the paper sheet 28, the image formed on the paper sheet 28, and the surface of the image forming drum 23. The in-line sensor 26 is an example of a reading device. The in-line sensor 26 includes a light source and a reading element, and linearly reads a reading target. Accordingly, the in-line sensor 26 can read the reading target in the main scanning direction at one time. When reading the paper sheet 28, the image formed on the paper sheet 28, and the surface of the image forming drum 23, the in-line sensor 26 continuously performs reading in the sub-scanning direction.

Since the in-line sensor 26 is positioned at a certain distance from the paper sheet 28 serving as the reading target, the image formed on the paper sheet 28, and the surface of the image forming drum 23, the in-line sensor 26 desirably employs a reduction optical system that reduces an image of the reading target to the original size and projects the reduced image on the reading element. In the case where the width of the in-line sensor 26 in the main scanning direction, which is the pixels in the main scanning direction, is insufficient for the width of the image forming drum 23 in the main scanning direction, the entire width of the image forming drum 23 in the main scanning direction can be read by the in-line sensor 26 that is configured such that multiple in-line sensors 26 are arranged in a staggered manner.

A channel plate having a large number of fine suction holes is attached to the surface of the image forming drum 23. The paper sheet 28 is sucked and conveyed while being kept in close contact with the channel plate. The channel plate is provided with recesses in order to prevent the paper sheet from floating due to the distortion of the paper sheet 28.

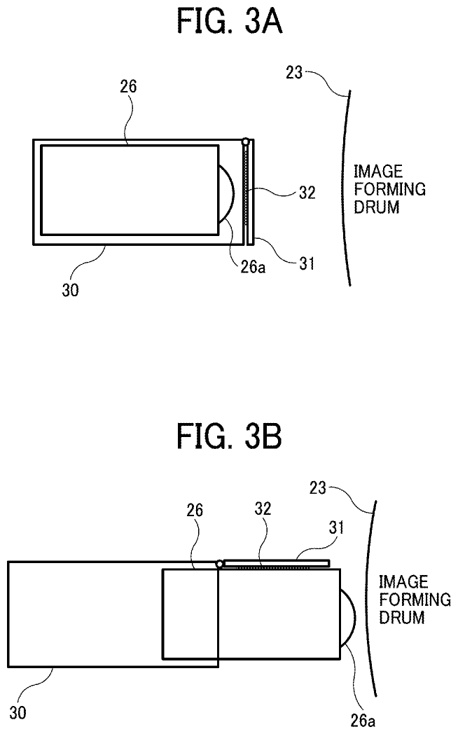

FIGS. 3A and 3B are enlarged views of the periphery of an in-line sensor according to a comparative example. The in-line sensor 26 is configured such that multiple in-line sensors 26 arranged in a staggered manner are used to read the entire width of the image forming drum 23 in the main scanning direction. As illustrated in FIG. 3A, the in-line sensor 26 is housed in a housing 30. A metal plate 31 that can be opened and closed using, for example, a hinge is disposed at a position facing a reading side 26a. A white reference plate 32 is attached to the side of the metal plate 31 facing the reading side 26a. The white reference plate 32 is one of white image providing objects that provide a white image used for adjusting the reading level of the in-line sensor 26.

The in-line sensor 26 reads the white reference plate 32 when the image processing apparatus 10 is turned on or starts printing to perform calibration on fluctuation factors of individual elements such as the light source and the reading element. The calibration performed for this purpose is called shading correction.

When the in-line sensor 26 reads the paper sheet 28 being conveyed, as illustrated in FIG. 3B, the reading side 26a moves toward the metal plate 31, pushes up the metal plate 31 to be opened, and approaches the image forming drum 23. Then, the in-line sensor 26 reads the paper sheet 28 on the surface of the image forming drum 23. For this purpose, the image processing apparatus 10 includes a driver that moves the in-line sensor 26 so that the in-line sensor 26 can read the white reference plate 32. Not only when reading the paper sheet 28 being conveyed but also when reading the image formed on the paper sheet 28 or the surface of the image forming drum 23, the reading side 26a pushes up the metal plate 31 to be opened and approaches the image forming drum 23 in a similar manner. Then, the in-line sensor 26 performs reading.

The calibration of the reading characteristics of the reading device such as the in-line sensor 26 includes a calibration called black shading adjustment, in addition to the calibration performed by reading the white reference plate 32. The black shading adjustment is an adjustment method in which the reading noise (e.g., dark current noise) of the reading device is obtained in advance, and the component of the reading noise is subtracted from the read image as an amount of density fluctuation to remove (cancel) the influence of the reading noise. Dark current is a phenomenon in which electric charges are generated even when no light is incident on the reading element.

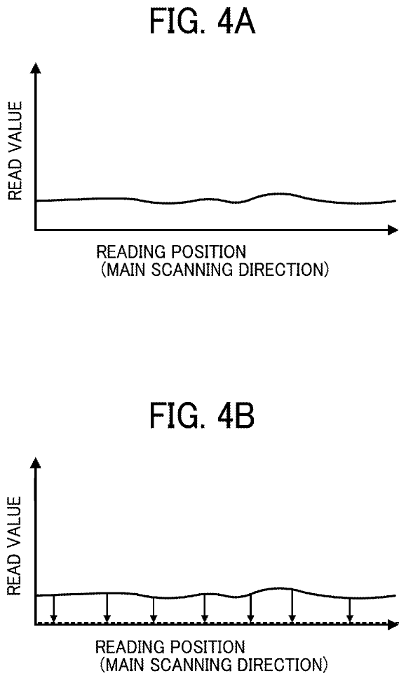

FIGS. 4A and 4B are diagrams each illustrating the black shading adjustment. FIG. 4A is a diagram illustrating a relationship between a reading position of the reading element of the in-line sensor 26 in the main scanning direction and a read value. In the drawing, a result of reading performed by the reading element when the light source is turned off is illustrated. Even when the light source is turned off, the read value is not zero because of the occurrence of, for example, dark current noise. The read value includes, in addition to a noise component of the dark current noise, a stray light component (an amount of density fluctuation due to stray light) because the stray light also has an influence.

FIG. 4B is a diagram illustrating how a noise component is subtracted in order to cancel the noise component. Since the read value also includes the stray light component, by subtracting the stray light component as well, the influence of the stray light as well as the influence of the dark current noise can be canceled by the black shading adjustment.

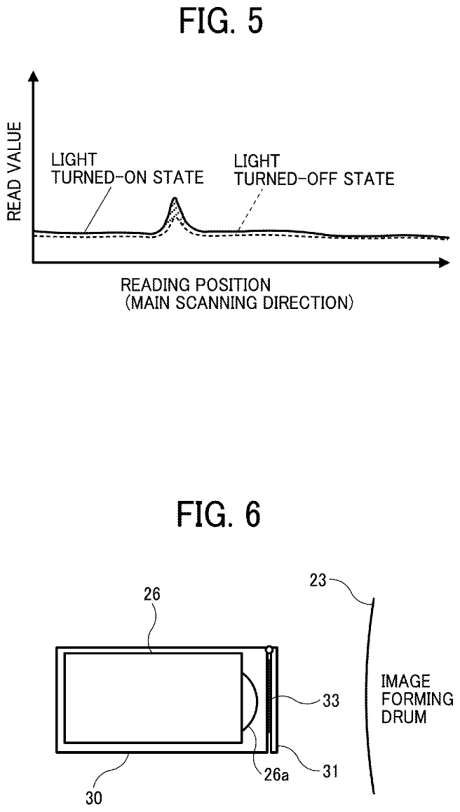

FIG. 5 is a diagram illustrating issues in canceling the stray light component. The stray light is light that is generated outside the originally intended optical path. The stray light includes light from a light source other than the light source of the in-line sensor 26 and light that is generated when the light from the light source of the in-line sensor 26 scatters and reflects on something other than the paper sheet 28 as the reading target.

In FIG. 5, the relationship between the reading position of the reading element of the in-line sensor 26 in the main scanning direction and the read value is also illustrated. FIG. 5 illustrates that the read value indicates a peak at a certain position in the main scanning direction and the stray light component is obtained at that position. FIG. 5 illustrates the results when the stray light component is obtained in a state where the light source of the in-line sensor 26 is turned on, and when the stray light component is obtained in a state where the light source is turned off.

When the stray light component is obtained in the state where the light source of the in-line sensor 26 is turned on, an error other than the stray light component is also collected. Accordingly, when the adjustment with high sensitivity is performed for a read waveform, the adjustment with high sensitivity is affected.

When the stray light component is obtained in the state where the light source of the in-line sensor 26 is turned off, the stray light component has an exceedingly small value close to zero. Because of the characteristics of the reading element, the reading range is collapsed as illustrated in the hatched portion of FIG. 5, and the stray light component cannot be completely canceled. In this case, the error remaining without being completely canceled affects the adjustment of the image when the adjustment with high sensitivity is performed for the read waveform.

In view of the above, the image processing apparatus according to the present embodiment extracts only the stray light component, particularly only a locally large stray light component that may cause an image defect, and cancels the extracted stray light component from the image. FIG. 6 is a diagram illustrating a configuration of the periphery of the reading device included in the image processing apparatus 10 according to a first example. With this periphery of the reading device, only a locally large stray light component can be extracted.

The configuration illustrated in FIG. 6 is substantially the same as the configuration illustrated in FIG. 3. However, the reference plate attached to the metal plate 31 is a black reference plate 33 instead of the white reference plate 32 in the drawing. The black reference plate 33 is one of black image providing objects that provide a black image used for calculating a stray light component. The black image providing object that provides a black image is not limited to the black reference plate 33.

The black reference plate 33 is read by the reading element of the in-line sensor 26 in two states, i.e., a state where the light source of the in-line sensor 26 is turned on and a state where the light source of the in-line sensor 26 is turned off. The read images are transmitted, as a first black image and a second black image, to a read image processing unit serving as an image processing unit, which will be described later. The image processing apparatus 10 includes a driver that moves the in-line sensor 26 so that the in-line sensor 26 can approach and read the black reference plate 33.

In this configuration, the white reference plate 32 can be attached in place of the black reference plate 33, and the in-line sensor 26 can be moved by the driver to approach and read the white reference plate 32.

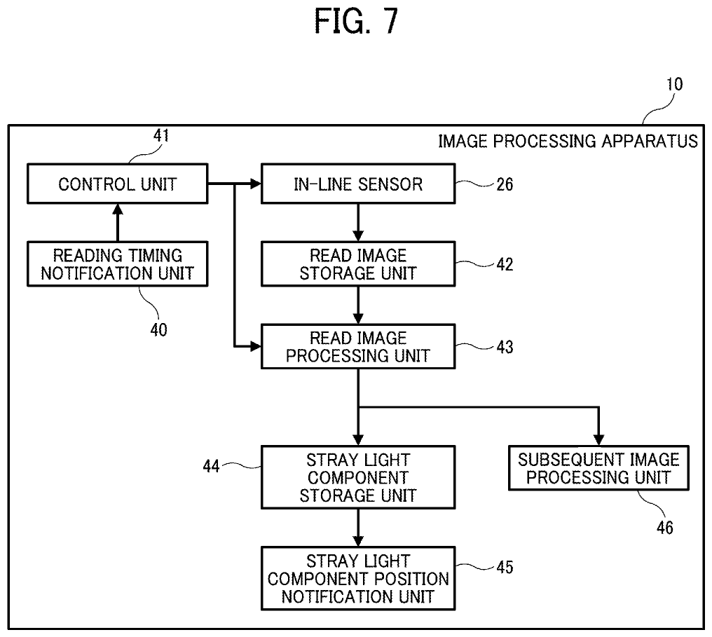

FIG. 7 is a block diagram illustrating a hardware configuration and a functional configuration of the image processing apparatus 10. The image processing apparatus 10 includes, in addition to the devices such as the sheet feeding device 11 illustrated in FIG. 1, a central processing unit (CPU), a read-only memory (ROM), a random-access memory (RAM), a communication interface, an engine controller, and a control panel. The CPU control the overall operation of the image processing apparatus 10. The ROM stores programs and data for implementing the functions of the image processing apparatus 10. The RAM is used for loading programs and data, and may also be used as a drawing memory for storing drawing data for printing.

The functions of the image processing apparatus 10 are implemented by the CPU reading out a program stored in the ROM to the RAM and executing the program. In another embodiment, the above-described functions may be implemented by devices such as an application-specific integrated circuit (ASIC), a digital signal processor (DSP), a field-programmable gate array (FPGA), and conventional circuit components designed to perform the recited functions.

The image processing apparatus 10 includes a reading timing notification unit 40, a control unit 41, a read image storage unit 42, a read image processing unit 43, a stray light component storage unit 44, a stray light component position notification unit 45, and a subsequent image processing unit 46. The functions of the image processing apparatus 10 are implemented by the corresponding functional units. In the present embodiment, the reading timing notification unit 40 and the stray light component position notification unit 45 are described as two separate units. However, those two units may be implemented by a single notification unit. Similarly, the read image processing unit 43 and the subsequent image processing unit 46 may be implemented by a single image processing unit, and the read image storage unit 42 and the stray light component storage unit 44 may be implemented by a single storage unit. The image processing apparatus 10 includes the in-line sensor 26 as hardware.

When the stray light component is obtained, the control unit 41 transmits, to the in-line sensor 26, a reading command to read the black reference plate 33. At this time, the control unit 41 issues the read command to read the black reference plate 33 in two states, i.e., a state where the light source is turned on and a state where the light source is turned off.

The black reference plate 33 read by the in-line sensor 26 is stored in the read image storage unit 42 as a first black image and a second black image. The read image processing unit 43 calculates a stray light component based on the first black image and the second black image stored in the read image storage unit 42, and stores the calculated stray light component in the stray light component storage unit 44 together with the position of the stray light component.

The stray light component position notification unit 45 notifies a user of the position of the stray light component stored in the stray light component storage unit 44 and prompts the user to select whether to cancel the stray light component for each position. The stray light component position notification unit 45 can cause the position of the stray light component to be displayed, for example, on the control panel to notify the position of the stray light component. At this time, the control panel displays a button for selecting whether to cancel the stray light component for each position to prompt the user to select whether to cancel the stray light component for each position. In this way, the user is allowed to cancel only a specific stray light component.

It is assumed that the user selects a specific stray light component on the control panel. The reading timing notification unit 40 notifies the control unit 41 to perform a process for canceling the selected stray light component when the paper sheet 28 being conveyed passes near the in-line sensor 26.

In response to receiving the notification, the control unit 41 transmits, to the in-line sensor 26, a reading command to read the paper sheet 28 being conveyed. The in-line sensor 26 causes the image obtained by reading the paper sheet 28 to be stored in the read image storage unit 42. The read image processing unit 43 uses the stray light component stored in the stray light component storage unit 44 to correct the image stored in the read image storage unit 42. In other words, the read image processing unit 43 removes the stray light component from the image. The read image processing unit 43 transmits, to the subsequent image processing unit 46, the image from which the stray light component is removed as data.

The subsequent image processing unit 46 performs, for example, shading correction on the image to be printed, based on the data received from the read image processing unit 43. The control unit 41 controls the amount of ink ejected from the line head based on the image to be printed on which the shading correction is performed and can cause printing to be executed.

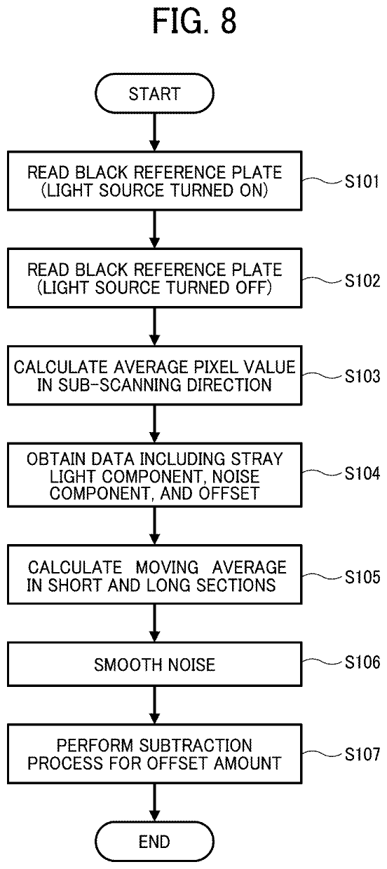

FIG. 8 is a flowchart of the process performed by the image processing apparatus 10 illustrated in FIG. 7. The image processing apparatus 10 starts the process when the image processing apparatus 10 is turned on or starts printing. This is just an example, and this process may be performed at any timing.

In step S101, the in-line sensor 26 reads, with the reading element, the black reference plate 33 when the light source of the in-line sensor 26 is turned on. In step S102, the in-line sensor 26 reads, with the reading element, the black reference plate 33 when the light source of the in-line sensor 26 is turned off. The order of reading the black reference plate 33 may be reversed. With this reading, a first black image is obtained as a reading result when the light source of the in-line sensor is turned on, and a second black image is obtained as a reading result when the light source of the in-line sensor is turned off.

In step S103, the average value of pixel values of pixels in the sub-scanning direction is calculated at each position in the entire width of the main scanning direction for each of the first black image and the second black image. When the tones from white to black are expressed by 256 bits, values from 0 to 255 can be used as the pixel values. The average value calculated for the first black image is defined as A, and the average value calculated for the second black image is defined as B. When calculating the average value, the number of lines in the sub-scanning direction for which the average value is calculated can be determined in advance, and the average value may not be the average value of all the lines in the sub-scanning direction.

In step S104, a subtraction “A−B” is performed at each position in the main scanning direction to obtain data of a component in which the stray light component, the noise component, and an offset (a component of deviation from a reference) are superimposed. Accordingly, the result of the subtraction “A−B” includes each piece of data of the stray light component, the noise component, and the offset. In some cases, the result of the subtraction “A−B” may be a negative value. In this case, the result of the subtraction “A−B” at that position in the main scanning direction is set to zero.

In step S105, a moving average is calculated for the result of the subtraction “A−B” at each position in the main scanning direction in a short section designated in the main scanning direction and a long section designated in the main scanning direction. It is assumed that the number of pixels in the main scanning direction is several hundred. For example, a section of several pixels is defined as the short section, and a section of several tens of pixels is defined as the long section, which is longer than the short section. This is just an example, and an appropriate number of pixels can be defined as each section. The moving average may be a simple moving average, an exponential moving average, or a weighted moving average. Since each moving average described above is well known, a detailed description thereof is omitted.

The reason for calculating the moving average in each of the short section and the long section is described below. The stray light component has an exceedingly small read value close to zero. In order to detect such a small value, it is necessary to reduce noise that tends to have a large fluctuation amount and flatten the components other than the stray light component. This is because when the components other than the stray light component are flattened, a component that fluctuates from the flat state can be extracted as the stray light component. For this purpose, a moving average is calculated for the short section to use the result to reduce the noise, and a moving average is calculated for the long section to use the result to flatten the components other than the stray light component. The stray light component ranges from a small component having little influence on an image defect to a locally large stray light component causing an image defect. By calculating a moving average in each of the short section and the long section, at least the locally large stray light component can be extracted.

In step S106, an average value of the data obtained by calculating the moving average in the short section for each position in the main scanning direction is calculated. A fixed value is added to the calculated average value to calculate a threshold value. The fixed value may be determined in advance using any suitable value. At this time, the value at each position in the main scanning direction is data obtained by calculating a moving average in the short section. After the threshold value is calculated, the value at each position in the main scanning direction is compared with the threshold value.

For example, it is assumed that the data at respective positions in the main scanning direction are 10, 12, 11, 16, 12, and so on, and the short section is three pixels. Using a simple moving average, the moving average of the first data value “10,” the second data value “12,” and the third data value “11” is calculated as “11.” As a result, the data value “12” at the second position from the left is replaced with “11.” Similarly, the third data value “11” is replaced with “13” and the fourth data value “16” is replaced with “13.” Accordingly, when the first data is used as it is, the values of the respective positions in the main scanning direction to be compared with the threshold value are 10, 11, 14, 14, and so on.

When the value at each position in the main scanning direction is smaller than the threshold value, the value is assumed to include the noise component and the offset, and is replaced with the data obtained by calculating a moving average in the long section at the same position. By contrast, when the value at each position in the main scanning direction is equal to or greater than the threshold value, the data obtained by calculating a moving average in the short section is used as it is because the value includes the stray light component in addition to the noise component and the offset. In this way, the noise is smoothed.

In step S107, by uniformly subtracting the average value of the data in which the noise has been smoothed from the data in which the noise has been smoothed at each position in the main scanning direction, the noise and the offset are removed. As a result, data including only the stray light component can be obtained. When the value at each position in the main scanning direction is smaller than the threshold value, the data in which the noise has been smoothed is data replaced by the data obtained by calculating a moving average in the long section at the same position. When the value at each position in the main scanning direction is equal to or greater than the threshold value, the data obtained by calculating a moving average in the short section remains as the data in which the noise has been smoothed. When the data including only the stray light component is extracted in this manner, the process for obtaining the stray light component ends.

Subsequently, in the image quality adjustment, by subtracting the data including only the stray light component obtained in step S107 from each pixel value of the read image read by the in-line sensor 26, the stray light component is removed from the read image.

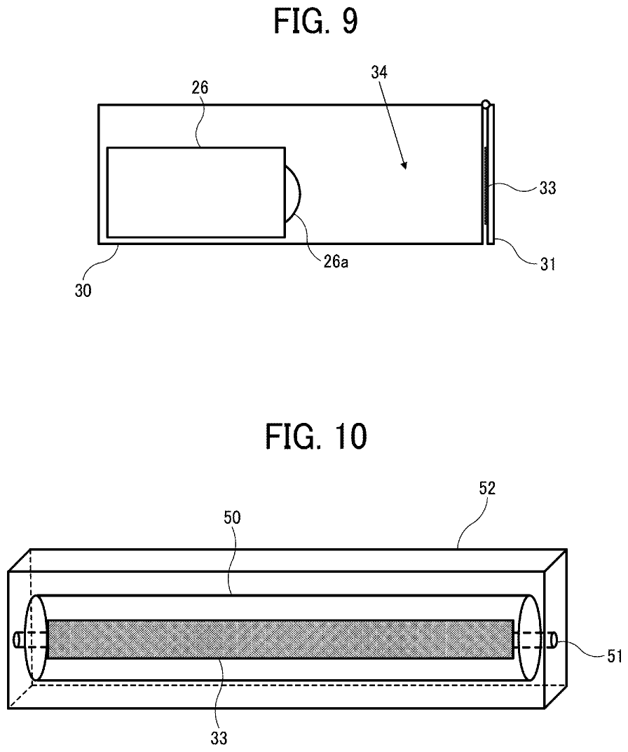

FIG. 9 is a diagram illustrating a configuration of the periphery of the reading device included in the image processing apparatus 10 according to a second example. In the example illustrated in FIG. 6, the black reference plate 33 is used as the black image providing object that provides a black image. In the example illustrated in FIG. 9, a dark space 34 that is provided when the size of a housing 30 is increased is used as the black image providing object that provides a black image. The dark space 34 is sufficiently wide to remain dark in the direction in which the reading side of the in-line sensor 26 faces even when the light source is turned on. The dark space 34 can be formed by increasing the size of the housing 30 that houses the in-line sensor 26. The size of the dark space 34 can be determined as a space size such that, when the metal plate 31 attached to the housing 30 in an openable and closable manner is closed and the light source of the in-line sensor 26 is turned on, the read value read by the reading element becomes equivalent to the read value obtained by reading the black reference plate 33 when the light source is turned on. By providing such a dark space, a black image can be obtained without providing the black reference plate 33, and the stray light component can be obtained in the same manner as described above.

In the example illustrated in FIG. 6, when the shading correction is performed, the black reference plate 33 needs to be removed and the white reference plate 32 needs to be attached. In the example illustrated in FIG. 9, the white reference plate 32 may remain attached to the metal plate 31. However, since the white reference plate 32 has a high reflectance of 100%, an appropriate black image may not be obtained. Accordingly, in the example illustrated in FIG. 9, it is also desirable to attach the white reference plate 32 when being used.

As described above, in the examples illustrated in FIGS. 6 and 9, the white reference plate 32 needs to be attached each time, and unless the white reference plate 32 is replaced with the black reference plate 33 or removed, the stray light component cannot be obtained, and the fluctuation of the stray light component over time cannot be absorbed.

In view of the above, by adopting a configuration in which the white reference plate 32 and the black reference plate 33 can be automatically switched, the time and effort used for attaching the white reference plate 32 can be eliminated and the fluctuation of the stray light component over time can be absorbed.

FIG. 10 is a diagram illustrating a configuration of the periphery of the reading device included in the image processing apparatus 10 according to a third example. As a configuration in which the white reference plate 32 and the black reference plate 33 can be automatically switched, for example, a configuration of a revolver may be adopted. In the example illustrated in FIG. 10, the white reference plate 32 and the black reference plate 33 are attached to the side surface of a cylindrical component 50 having a width larger than the width of the in-line sensor 26 in the main scanning direction. Specifically, the white reference plate 32 and the black reference plate 33 are attached at different positions in the circumferential direction of the cylindrical component 50. A rotation shaft 51 penetrates the center of a cross section of the cylindrical component 50. A lid 52 to cover the periphery of the cylindrical component 50 except for the surface facing the reading side of the in-line sensor 26 is rotatably supported by the rotation shaft 51. In this configuration, by rotating the rotation shaft 51, the white reference plate 32 or the black reference plate 33 can be positioned opposite the reading side of the in-line sensor 26, and the white reference plate 32 can be switched to the black reference plate 33 or vice versa.

In the example illustrated in FIG. 10, instead of the metal plate 31 attached, in an openable and closable manner, to the housing 30 housing the in-line sensor 26, the lid 52 covering the cylindrical component 50 is attached in an openable and closable manner, and the black reference plate 33 is positioned opposite the reading side of the in-line sensor 26. The white reference plate 32 is attached to a surface of the cylindrical component 50 at the back of the black reference plate 33, and is hidden by the cylindrical component 50 in the example illustrated in FIG. 10. In this case, when switching to the white reference plate 32, the rotation shaft 51 is rotated by approximately 180 degrees so that the white reference plate 32 can be positioned opposite the reading side of the in-line sensor 26.

Accordingly, the stray light component can be obtained each time the in-line sensor 26 operates, and thus the fluctuation of the stray light component over time can be absorbed. The configuration illustrated in FIG. 10 is given by way of example, and any known configuration may be adopted as long as the white reference plate 32 and the black reference plate 33 can be automatically switched. The white reference plate 32 and the black reference plate 33 may not be automatically switched, but may be manually switched.

According to the technique in the art, since the components other than the stray light component are also corrected in order to remove the stray light component that causes an image defect, an issue is caused that image unevenness occurs due to the correction of the other components and an image defect occurs.

As described above, the image processing apparatus, the image processing method, and the non-transitory recording medium according to the above embodiments of the present disclosure reduce the occurrence of image unevenness and eliminate the occurrence of the image defect. Further, by providing the dark space 34, the data including only the stray light component is obtained without using the black reference plate 33.

By adopting a configuration in which the white reference plate 32 and the black reference plate 33 can be automatically switched, the fluctuation of the stray light component over time can be absorbed. Further, by adopting a configuration in which the user is notified of the position of the stray light component after the stray light component is obtained and the user is allowed to select whether to cancel the stray light component at the position, the user is allowed to designate a position to be cancelled at will, at which the stray light component is located, and thus only a specific stray light component can be removed.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing apparatus comprising:
a reading sensor to read an image;
a black image providing object to provide a black image for calculating an amount of density fluctuation due to stray light; and
circuitry configured to:
calculate the amount of density fluctuation based on a first black image and a second black image read by the reading sensor in states where a light source is turned on and off for the black image providing object, respectively; and
correct the image read by the reading sensor using the amount of density fluctuation.

2. The image processing apparatus according to claim 1,
wherein the black image providing object is a black reference plate positioned opposite a reading side of the reading sensor.

3. The image processing apparatus according to claim 1,
wherein the black image providing object is a housing that houses the reading sensor, the housing forming a dark space in a direction in which a reading side of the reading sensor faces even in a case that the light source is turned on.

4. The image processing apparatus according to claim 1, further comprising:
a white reference plate used for adjusting a reading level of the reading sensor; and
a rotary cylindrical component wherein:
the black image providing object is a black reference plate; and
the black reference plate and the white reference plate are attached to a side surface of the cylindrical component at different positions in the circumferential direction of the cylindrical component such that positions of the black reference plate and the white reference plate are switched by rotating the cylindrical component.

5. The image processing apparatus according to claim 1, wherein the circuitry is further configured to:
specify, based on the first and second black images, one or more positions where the density fluctuation occurs due to the stray light; and
indicate the positions.

6. The image processing apparatus according to claim 1, further comprising:
a white reference plate used for adjusting a reading level of the reading sensor; and
a driver to move the reading sensor to read one of the white reference plate and the black image providing object.

7. The image processing apparatus according to claim 1, wherein the circuitry is further configured to:
obtain data at each of positions in a main scanning direction using the first and second black images, the data including the amount of density fluctuation due to the stray light, the amount of density fluctuation due to noise, and an offset;
calculate a moving average of the data in a first section in the main scanning direction and a second section for each of the positions, the second section being longer than the first section;
calculate an average value of the moving average calculated for each of the positions;
a value obtained by adding a fixed value to the average value is set as a threshold value; and
in a case that the moving average calculated in the first section is smaller than the threshold value, replace the moving average calculated in the first section with the moving average calculated in the second section at a same position of the moving average calculated in the first section in the main scanning direction.

8. An image processing method comprising:
calculating an amount of density fluctuation based on a first black image and a second black image read by a reading sensor, respectively, in states where a light source is turned on and off for a black image providing object used for calculating the amount of the density fluctuation due to stray light;
reading, with the reading sensor, an image used for performing density correction; and
correcting the image read by the reading sensor using the amount of the density fluctuation.

9. A non-transitory recording medium storing a plurality of program codes which, when executed by one or more processors, causes the one or more processors to perform a method, the method comprising:
calculating an amount of density fluctuation based on a first black image and a second black image read by a reading sensor, respectively, in states where a light source is turned on and off for a black image providing object used for calculating the amount of the density fluctuation due to stray light;
reading, with the reading sensor, an image used for performing density correction; and
correcting the image read by the reading sensor using the amount of the density fluctuation.
